(19) United States
(12) Patent Application Publication
(10) Pub. No.: US 2013/0147605 A1
(43) Pub. Date: Jun. 13, 2013

(54) LOW POWER WIRELESS SENSING SYSTEM

(71) Applicants: Chia-Chi Chang, Taoyuan County (TW); Jang Ping Sheu, Hsinchu City (TW)

(72) Inventors: Chia-Chi Chang, Taoyuan County (TW); Jang Ping Sheu, Hsinchu City (TW)

(21) Appl. No.: 13/523,609

(22) Filed: Jun. 14, 2012

(30) Foreign Application Priority Data
Dec. 9, 2011 (TW) 100145543

(51) Int. Cl. G08C 17/02

(52) U.S. Cl. 340/10.1

(57) ABSTRACT

A low power wireless sensing system includes: a sensing device senses a peripheral environment to generate sensing data; a transmission device, coupled to the sensing device, is connected to an external network through a communication protocol to establish a wireless sensing network; a storage device stores the sensing data or first firmware; and a microprocessing device generates a control signal to control operations of the sensing device, transmission device and storage device according to the sensing data or a RF signal of the external network. The microprocessing device determines to read the first firmware according to the RF signal, so that second firmware built in the microprocessing device is updated and the control signal is adjusted correspondingly. The microprocessing device makes the transmission device enter a sleep state or perform reconnecting according to the RF signal.

This application claims priority of No. 100145543 filed in Taiwan R.O.C. on Dec. 9, 2011 under 35 USC 119, the entire content of which is hereby incorporated by reference.

### BACKGROUND OF THE INVENTION

1. Field of the Invention

The invention relates to a system, and more particularly to a low power wireless sensing system.

2. Related Art

The application scopes of wireless sensing systems may include environment monitoring, military uses, medical monitoring, industry monitoring, meter control, commercial building automation control, family daily life monitoring, consumer electronic goods, and the like. So, the wireless sensing system has huge business opportunities.

If the wireless sensing system is located in dangerous areas, such as a volcanic area, a nuclear power plant and the like, when the firmware inside the wireless sensing system needs to be updated, the wireless sensing system cannot be immediately updated but needs to be replaced with a new one with the updated firmware by the repairer. So, the user tends to feel inconvenient, and the repairer is exposed to the highly dangerous environment.

### SUMMARY OF THE INVENTION

An object of the invention is to provide a low power wireless sensing system capable of remotely performing firmware updating.

Another object of the invention is to provide a low power wireless sensing system having the low power-consumptive property.

An embodiment of the invention provides a low power wireless sensing system including a sensing device, a transmission device, a storage device and a microprocessing device. The sensing device is for sensing a peripheral environment to generate sensing data. The transmission device is coupled to the sensing device and connected to an external network through a communication protocol to establish a wireless sensing network. The storage device is for storing the sensing data or first firmware. The microprocessing device generates a corresponding control signal to control corresponding operations of the sensing device, the transmission device and the storage device to according to the sensing data or a radio frequency (RF) signal of the external network. The microprocessing device determines to read the first firmware according to the RF signal, so that second firmware built in the microprocessing device is correspondingly updated and the control signal is adjusted correspondingly. The microprocessing device makes the transmission device enter a sleep state or perform reconnecting according to the RF signal.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a low power wireless sensing system according to an embodiment of the invention.

FIG. 2 is a schematic illustration showing a low power wireless sensing system according to an embodiment of the invention.

FIG. 3 is a schematic illustration showing a low power wireless sensing system according to an embodiment of the invention.

### DETAILED DESCRIPTION OF THE INVENTION

The present invention will be apparent from the following detailed description, which proceeds with reference to the accompanying drawings, wherein the same references relate to the same elements.

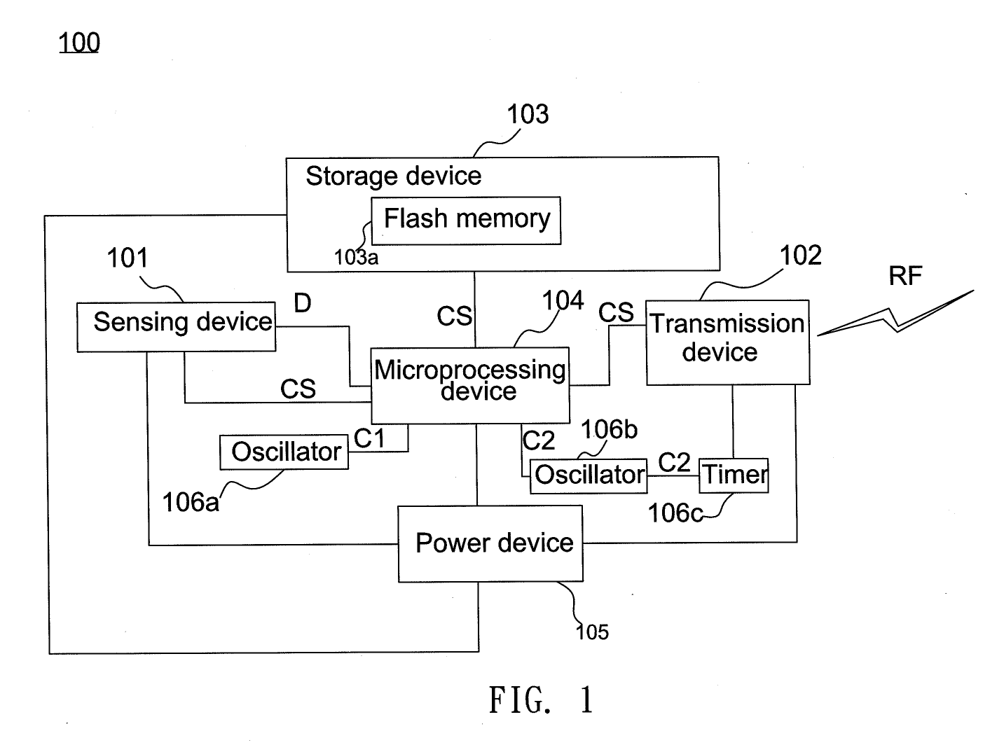

FIG. 1 is a schematic illustration showing a low power wireless sensing system 100 according to an embodiment of the invention. Referring to FIG. 1, the low power wireless sensing system 100 includes a sensing device 101, a transmission device 102, a storage device 103 and a microprocessing device 104.

In an embodiment, the sensing device 101 may be implemented by a temperature, humidity or illumination sensing device. However, the invention should not be restricted thereto, and the required sensing device may be used according to the user's requirement. So, the sensing device 101 may generate sensing data D by sensing the environment where the wireless sensing system 100 is located and according to the environmental factor required by the user.

The transmission device 102 is coupled to the sensing device 101 and connected to an external network through a wireless communication protocol to establish a wireless sensing network. It is to be noted that the low power wireless sensing system 100 in an embodiment is connected to the external network (not shown) through the ZigBee wireless communication protocol to satisfy the power-saving requirement and have the wireless transmission advantage. In addition, the system 100 performs the packet transmission with other sensing systems through ZigBee and thus establishes a complete wireless sensing network. In this embodiment, the transmission device 102 performs the packet transmission with the external network through a radio frequency (RF) signal RF. In this embodiment, the transmission device 102 performs the data transmission through an Inverted-F PCB antenna.

The storage device 103 coupled to the sensing device 101 stores the sensing data D, and may additionally store the firmware F1 (not shown). The microprocessing device 104 is coupled to the sensing device 101, the transmission device 102 and the storage device 103. The microprocessing device 104 generates a corresponding control signal CS to control corresponding operations of the sensing device 101, the transmission device 102 and the storage device 103 to according to the sensing data D or the radio frequency signal RF of the external network.

It is to be noted that the low power wireless sensing system 100 of the invention remotely updates the firmware. In an embodiment, the user may transmit the firmware F1 to the storage device 103 for storage through the radio frequency signal RF. In other words, the firmware F1 can be transmitted to the transmission device 102 through the radio frequency signal RF, and again transmitted to the microprocessing device 104 from the transmission device 102, and the microprocessing device 104 transmits the firmware Fl to the flash memory of the storage device 103 for storage. So, when the user needs to update the original firmware F2 (not shown) of the low power wireless sensing system 100, the radio frequency signal RF can be transmitted to the microprocessing device 104 through the external network, and the microprocessing device 104 determines to read the firmware F1 according to the radio frequency signal RF, so that the original firmware F2 built in the microprocessing device 104 is correspondingly updated, while the control signal CS is adjusted correspondingly. In other words, when the environment where the low power wireless sensing system 100 is located is changed, or the original firmware F2 needs the essential updating, the user can remotely update the original firmware F2 through the external network.

In this embodiment, the storage device 103 further has a flash memory 103a for storing the sensing data and the firmware F1.

In another embodiment, the microprocessing device 104 makes the transmission device 102 enter a sleep state or perform a reconnecting mechanism according to the radio frequency signal RF. When the low power wireless sensing system 100 is idle or needs not to operate, the user may make the microprocessing device 104 generate the control signal CS according to the radio frequency signal RF to control the transmission device 102 to enter the sleep state to save the power consumption. When the low power wireless sensing system 100 needs to perform the environment sensing, the user can make the microprocessing device 104 generate the control signal CS to control the transmission device 102 according to the radio frequency signal RF, so that the transmission device 102 is woken up to perform the data transmission.

In an embodiment, the low power wireless sensing system 100 further includes a power device 105, which provides the required powers for the microprocessing device 104, the sensing device 101, the transmission device 102 and the storage device 103. In this embodiment, the power device 105 uses a 350 mAh polymer lithium battery. However, the invention should not be restricted thereto.

In addition, the low power wireless sensing system 100 further includes oscillators 106a and 106b. It is to be noted that when the transmission device 102 performs the data transmission, the microprocessing device 104 operates according to a clock C1 provided by the oscillator 106a. When the transmission device 102 enters the sleep state, the microprocessing device 104 operates according to a clock C2 provided by the oscillator 106b. Consequently, when the transmission device 102 enters the sleep state, the microprocessing device 104 turns off the higher frequency oscillator 106a and uses the lower frequency oscillator 106b to save the power consumption. In an embodiment, the frequency of the clock C1 is 32 MHz, and the frequency of the clock C2 is 32.768 KHz.

In another embodiment, a sleep timer 106c counts the time according to the clock C2, and wakes up the sleeping transmission device 102 within a predetermined time.

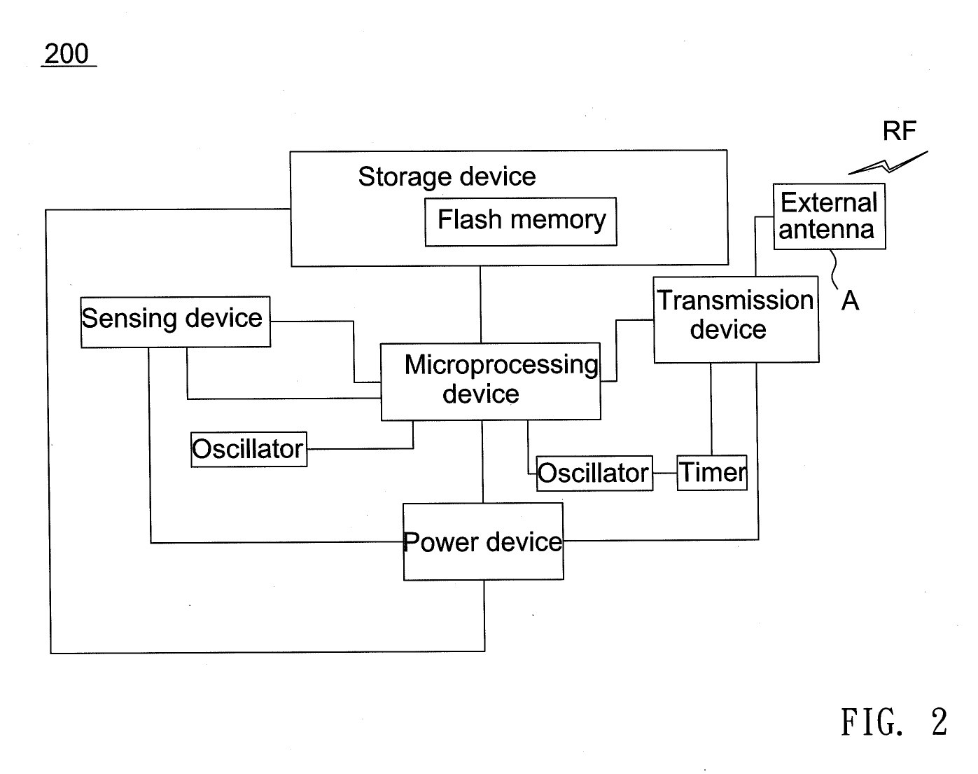

FIG. 2 is a schematic illustration showing a low power wireless sensing system 200 according to an embodiment of the invention. As shown in FIG. 2, the difference between the low power wireless sensing systems 200 and 100 resides in that the low power wireless sensing system 200 may be externally connected to an antenna A to transmit the radio frequency signal RF. In this embodiment, the low power wireless sensing system 200 utilizes the I-PEX antenna. The other operation principles will be omitted for the sake of conciseness.

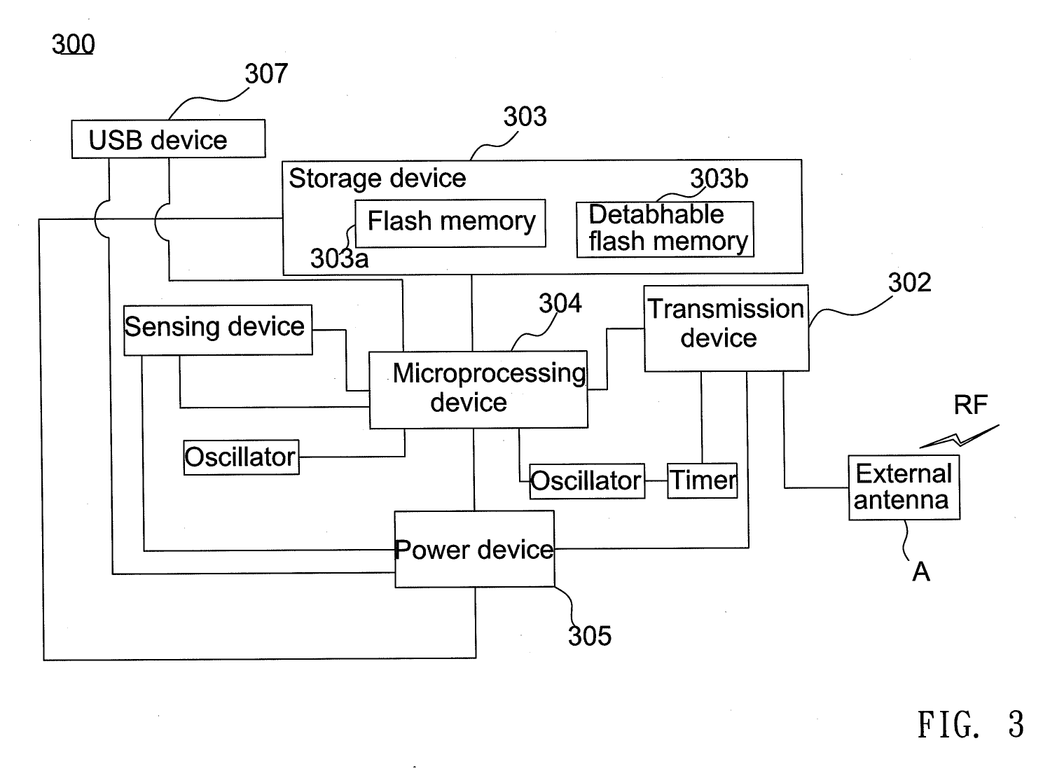

FIG. 3 is a schematic illustration showing a low power wireless sensing system 300 according to an embodiment of the invention. As shown in FIG. 3, the difference between the low power wireless sensing systems 300 and 100 resides in a storage device 303, which has a detachable flash memory 303b in addition to an external flash memory 303a.

It is to be noted that the user can use the external flash memory 303a and the detachable flash memory 303b exclusively or concurrently. In this embodiment, the detachable flash memory 303b may be implemented by the MicrSD to store a lot of sensing data. The flash memory 303a may provide the higher access speed, and is particularly suitable for the remote firmware updating.

In an embodiment, the user may store the firmware Fl into the detachable flash memory 303b in advance, and make the microprocessing device 304 perform the corresponding updating by the replacement of the detachable flash memory 303b.

The low power wireless sensing system 300 further includes a universal serial bus (USB) device 307, which is coupled to the storage device 303 and the microprocessing device 304. The user can read the sensing data from the storage device 303 through the USB device 307. In an embodiment, the user can transmit the firmware F3 to the storage device 303 through the USB device 307 and perform the firmware updating of the microprocessing device 304 when needed.

It is to be noted that the USB device 307 is coupled to the power device 305, so that the power device 305 may supply the power through a USB power. In this embodiment, the USB device 307 can obtain the main electric power source through the USB power without losing the internal battery power.

In addition, the transmission device 302 can perform the data transmission through the Inverted-F PCB antenna and the external antenna A concurrently. In this embodiment, the low power wireless sensing system 300 uses the I-PEX antenna.

In summary, the system of the invention has a wireless sensing node with a long distance transmission ability. In an embodiment, the data transmission and the power supply can be provided through a USB port, thereby facilitating the connection to a desktop computer or a notebook computer. In addition, the sensing system of the invention has the low implementation cost, the wireless transmission ability and the low power consumption.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A low power wireless sensing system, comprising:
a sensing device for sensing a peripheral environment to generate sensing data;
a transmission device, which is coupled to the sensing device and connected to an external network through a wireless communication protocol to establish a wireless sensing network;
a storage device for storing the sensing data or first firmware; and
a microprocessing device for generating a corresponding control signal to control corresponding operations of the sensing device, the transmission device and the storage device to according to the sensing data or a radio frequency (RF) signal of the external network, wherein:
the microprocessing device determines to read the first firmware according to the RF signal, so that second firmware built in the microprocessing device is correspondingly updated and the control signal is adjusted correspondingly; and
the microprocessing device makes the transmission device enter a sleep state or perform reconnecting according to the RF signal.

2. The system according to claim 1, wherein the storage device has a flash memory, and a user may store the first firmware into the flash memory in advance, or transmit the first firmware to the flash memory through the RF signal.

3. The system according to claim 2, wherein the first firmware may be transmitted to the transmission device through the RF signal, and again transmitted to the microprocessing device from the transmission device, and the microprocessing device transmits the first firmware to the flash memory for storage.

4. The system according to claim 2, wherein:
the storage device further has a detachable flash memory; and
the user stores the first firmware into the detachable flash memory in advance, or transmits the first firmware to the detachable flash memory through the RF signal.

5. The system according to claim 1, wherein the transmission device may transmit the RF signal through an external antenna.

6. The system according to claim 1, further comprising a power device, which provides powers for the microprocessing device, the sensing device, transmission device and the storage device.

7. The system according to claim 3, further comprising a universal serial bus (USB) device, which is coupled to the storage device and the microprocessing device, and the user may read the sensing data of the storage device through the USB device.

8. The system according to claim 7, wherein the user may transmit third firmware to replace the first firmware through the USB device.

9. The system according to claim 8, wherein the USB device is coupled to the power device, which may supply a power through a universal serial bus power.

10. The system according to claim 1, further comprising a first oscillator and a second oscillator, wherein:
when the transmission device performs data transmission, the microprocessing device operates according to a first clock provided by the first oscillator; and
when the transmission device enters the sleep state, the microprocessing device operates according to a second clock provided by the second oscillator, wherein a frequency of the first clock is higher than a frequency of the second clock.
